(19) United States
(12) Patent Application Publication
(10) Pub. No.: US 2010/0228716 A1
(43) Pub. Date: Sep. 9, 2010

(54) PROTOCOL PROCESSING APPARATUS AND METHOD

(75) Inventor: Kazuhiko Morimura, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/717,803

(22) Filed: Mar. 4, 2010

(30) Foreign Application Priority Data
Mar. 9, 2009 (JP) 2009-055212

(51) Int. Cl. G06F 17/30

(52) U.S. Cl. 707/707; 707/E17.037

(57) ABSTRACT

An apparatus includes a generation unit configured to generate an address to be provided to a database, a plurality of search units, and a processing unit configured to perform a network protocol processing based on a search result, wherein the search units, including an input unit configured to input a search key, a comparison unit configured to compare data output from the database and the search key input, a setting unit configured to set a search start address and a search end address, and a monitoring unit configured to monitor matching of the generated address and the search end address.

### BACKGROUND OF THE INVENTION

1. Field of the Invention

The present invention relates to a protocol processing apparatus and a method therefor.

2. Description of the Related Art

In network protocol processing, search processing based on a database termed a table is performed. Typical search processing includes a plurality of search processing such as an address resolution protocol (ARP) table search, socket table search, TCP control block (TCPCB) search, and routing table search. Loads caused by such search processing increase with growth of the network scale and a method for performing processing using hardware (or a dedicated processor) termed a dedicated search engine may be used.

A dedicated memory device termed a content addressable memory (CAM) is known and used in such a search engine. The CAM is a special memory that, when a search key (data) is input, outputs an address where registration data matching the search key is stored. Because the CAM simultaneously outputs registration data from all memory cells storing the registration data to compare them with the search key, a search can be performed at very high speed. However, the instantaneous current when registration data is output from all memory cells simultaneously, is large and a production process that is different from the process of normal logic is needed, CAM devices entail high cost.

As an alternative to the expensive CAM, an associative memory of a mode is known that uses a random access memory (RAM) and outputs results of successive comparison. Japanese Patent Application Laid-Open No. 2001-160291 discusses an associative memory as illustrated in FIG. 4. The associative memory, as its feature, can be realized at low cost by using an inexpensive RAM device without using a dedicated CAM and a plurality of searches can be performed at the same time, though the successive comparison is performed.

According to Japanese Patent Application Laid-Open No. 2001-160291, an address generation circuit 404 connected to the RAM sequentially outputs registration data in reference data memories 405, to realize the associative memory. Then, matching determinations with each search key are made by a plurality of matching determination circuits 406 and addresses are output when matched. The number of the reference data memories 405 is thereby reduced and a plurality of searches can be carried out at the same time.

However, in the above conventional device, if another search is requested while some search is being performed, another search cannot be performed before the search being performed terminates.

### SUMMARY OF THE INVENTION

According to an aspect of the present invention, an apparatus including a generation unit configured to generate an address to be provided to a database, a plurality of search units, and a processing unit configured to perform the network protocol processing based on a search result by the plurality of search units. Each of the plurality of search units include, wherein the plurality of search units, including an input unit configured to input a search key, a comparison unit configured to compare data output from the database according to the address generated by the generation unit and the search key input by the input unit, a setting unit configured to set a search start address and a search end address generated by the generation unit, and a monitoring unit configured to monitor matching of the address generated by the generation unit and the search end address, wherein if another search request is issued while at least one of the plurality of search units is performing a search, data output from the database for the search being performed and the search key for another search are compared by a search unit other than the search unit performing the search and the search end address of another search is set based on the address where another search is started.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a block diagram of an associative memory according to an exemplary embodiment of the present invention.

FIG. 2 is an address map of a search database according to the exemplary embodiment of the present invention.

FIG. 3 is an operation sequence diagram of each comparing apparatus according to the exemplary embodiment of the present invention.

FIG. 4 illustrates the associative memory in a conventional example.

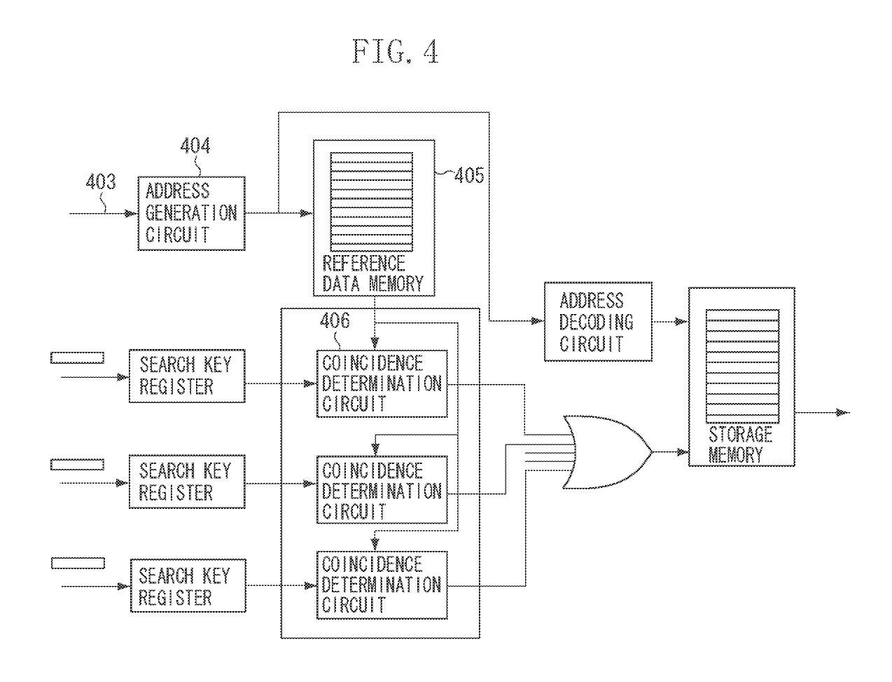

FIG. 5 is an example of a network apparatus (protocol processing apparatus) including a search apparatus.

FIG. 6 is a configuration example of a network.

FIG. 7 is an example of a routing table.

FIG. 8 illustrates a comparator according to the exemplary embodiment of the present invention.

### DESCRIPTION OF THE EMBODIMENTS

Various exemplary embodiments, features, and aspects of the invention will be described in detail below with reference to the drawings.

A first exemplary embodiment according to the present invention will be described below in detail with reference to attached drawings.

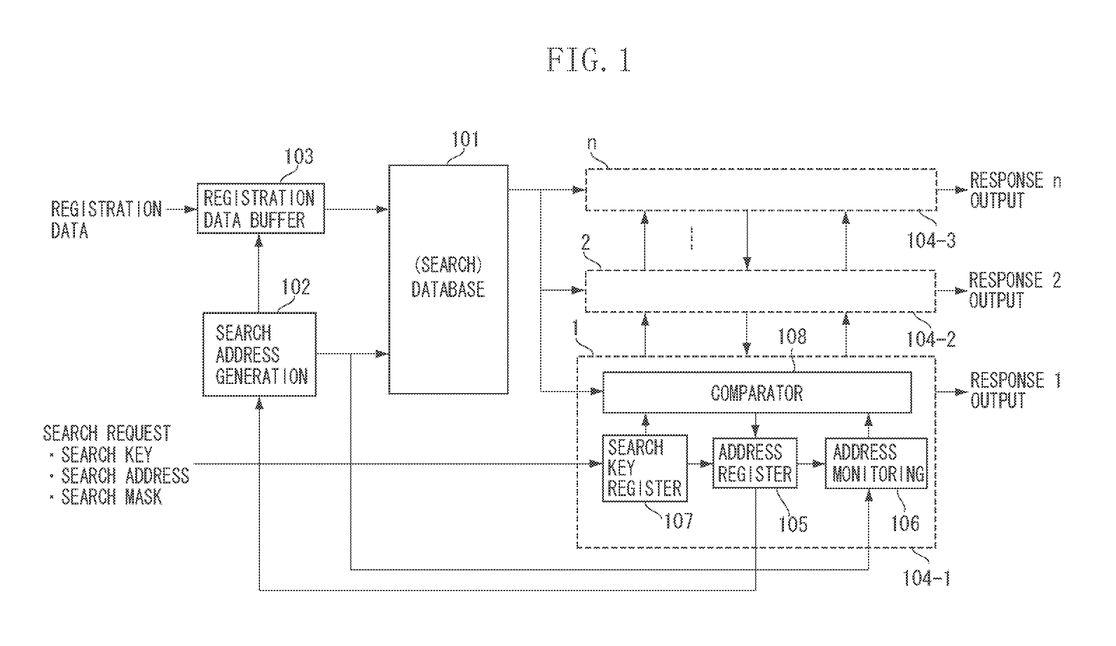

FIG. 1 is a diagram illustrating a configuration example of an associative memory embodying the present invention.

In FIG. 1, an associative memory includes a search database 101 using a memory such as a static RAM (SRAM), a search address generation apparatus 102 that generates a search address of the search database 101, and a registration data buffer 103 that temporarily stores registration data for the search database 101.

A comparing/search apparatus (search device) 104 compares output from the search database 101 and a search key. The comparing/search apparatus (search device) 104 also provides a search start address to the search address generation apparatus 102 and monitors a generated address. In FIG. 1, n units of the comparing/search apparatus (search device) 104 are provided. Hereinafter, the first comparing/search apparatus (search device) may be referred to as a comparing/search apparatus 1, the second comparing/search apparatus (search device) a comparing/search apparatus 2, and so on.

The comparing/search apparatus (search device) 104 includes an address register 105, an address monitoring apparatus 106, a search key register 107, and a comparator 108. The address register 105 holds search start/end addresses in the search database 101. The address register 105 sets the search start address and the search end address generated by the search address generation apparatus 102. The search address generation apparatus 102 generates addresses in order starting with a search start address set to the address register 105 and outputs the addresses to the search database 101. The address monitoring apparatus 106 controls the search address generation apparatus 102 and also monitors address output. More specifically, the address monitoring apparatus 106 monitors matching of the address generated by the search address generation apparatus 102 and the search end address set to the address register 105. The search key register 107 receives and holds a search key (data to be retrieved) and the comparator 108 compares output from the search database 101 and content of the search key register 107.

The search database 101 outputs data according to an address generated by the search address generation apparatus 102 and the comparator 108 compares data output from the search database and a search key input and held in the search key register.

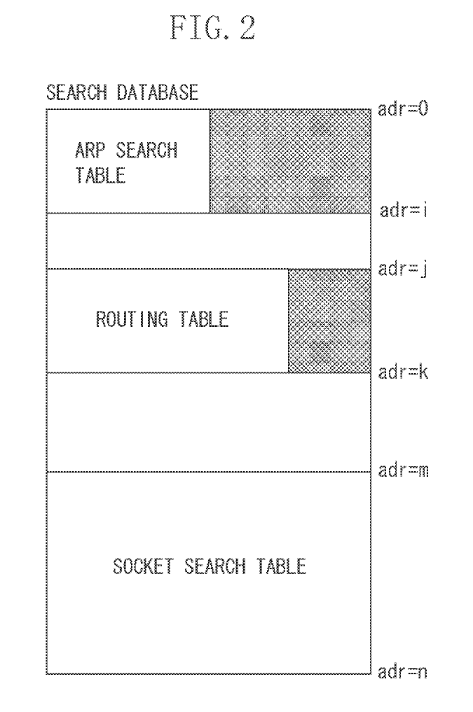

First, information in the search database 101 will be described. In network protocol processing, a plurality of search processing such as an ARP table search, socket table search, and routing table search is performed and the width of search keys and depth of search (number of items to be retrieved) are different depending on the search object. FIG. 2 illustrates a storage example of such a database. As illustrated in FIG. 2, the bit width necessary for one search and the amount of data registered in a table are normally different depending on the search type and the arrangement of address where each table is stored is also different. The first exemplary embodiment will be described based on the search database illustrated in FIG. 2.

First, a basic search operation in the first exemplary embodiment will be described. When the search key and search type are input into the search key register 107, the comparing/search apparatus 104 issues start/end addresses in the search database 101 according to search type, to the address register 105 and notifies the address monitoring apparatus 106 thereof. The address register 105 sets a (search) start address and a (search) end address generated by the search address generation apparatus 102. If the search type is the ARP search, the start address is 0 and the end address i. The address monitoring apparatus 106 makes sure that the search address generation apparatus 102 has generated no address and then instructs the search address generation apparatus 102 to start generation of search addresses. The search address generation apparatus 102 generates addresses to be provided to the search database 101. Accordingly, addresses from the start address to the end address are continuously provided from the search address generation apparatus 102 to the search database 101.

Registration data corresponding to each address is output from the search database 101 and a comparison is made with a search key in the search key register 107 by the comparator 108. At this point, the comparator 108 selects registration data in the search database 101 and a search key as comparison objects and compares only data of the bit width defined for the search type. FIG. 2 shows that the ARP table search, routing table search, and socket table search have different bit widths to be compared. The ARP table search, routing table search, and socket table search have bit widths to be compared, which increase in this order. If the comparison results match, matching information is output as response output.

At the time, if output of a response is requested for one search input, the search address generation apparatus 102 terminates the search. If, however, output of a plurality of responses is requested for one search input, the search address generation apparatus 102 continues to generate a search address. The search terminates when output from the search database 101 is completed up to the end address in this manner. The address monitoring apparatus 106 monitors matching of the address generated by the search address generation apparatus 102 and the (search) end address and terminates the search when both addresses match.

Next, a search operation when a plurality of search requests is made to one search object will be described.

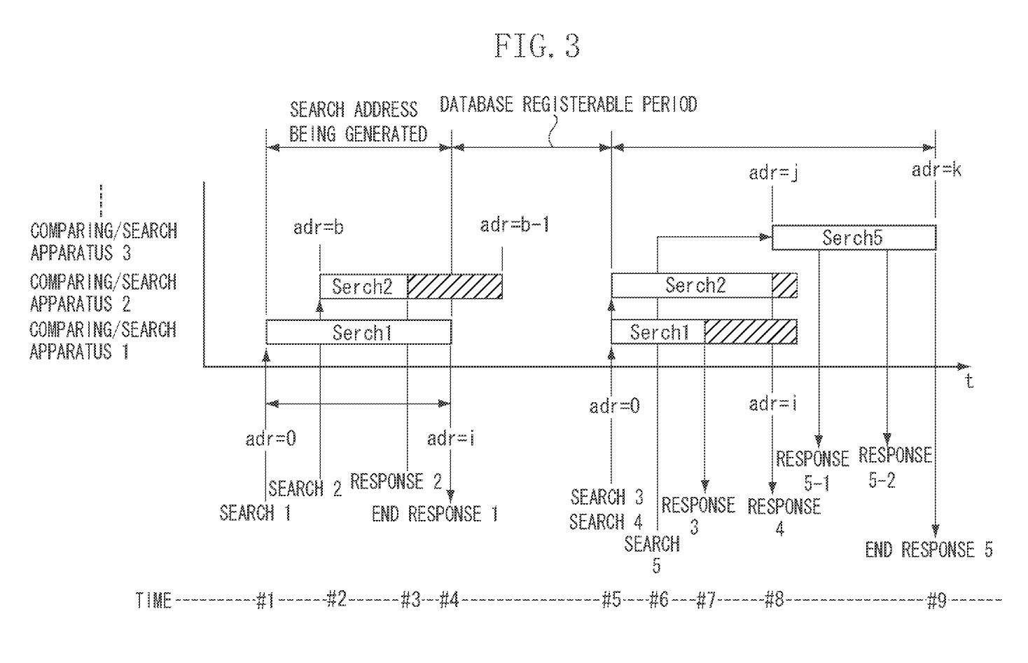

FIG. 3 is a diagram illustrating a search example performed by the comparing apparatus in FIG. 1 in time sequence. The vertical axis illustrates operation conditions of each comparing apparatus and the horizontal axis represents the time.

First, when a search 1 is input at time #1, “Search 1” by the comparing/search apparatus 1 is started. The search 1 is an ARP table search in which the ARP search table in FIG. 2 is a search object. At this point, the start address=0 and the end address=i are simultaneously provided as values of the address register 105 in the comparing/search apparatus 1. It is assumed that a single hit or multi-hit should be selected in advance as the type of a search result to be obtained. The single hit is a search that terminates when the data same as a search key is found in the search database and is a search to obtain a single search result. The multi-hit, by contrast, is a search that performs a search in a given search range of the search database to enable output of a plurality of search results.

Since the single hit is selected in the search 1, the search terminates when a “response 1” output from the comparing/search apparatus 1 is obtained, so that the search by the comparing/search apparatus 1 terminates before the end address=i. In FIG. 3, data matching the search key of the search 1 does not exist and thus, when the search up to the end address=i terminates, the “response 1” of completion is output from the comparing/search apparatus 1.

In the example in FIG. 3, a search 2 whose search object is the same as that of the search 1 is input at time #2 before the “response 1” is output. At this point, the comparing/search apparatus 1 is in the process of performing the “Search 1” and has completed comparison up to the search address adr=b−1. The search 2 is also an ARP table search. Since the search object of the search 2 is the same as that of the search 1, a comparison using the comparing/search apparatus 1 and the comparing/search apparatus 2 is made using output of the same search database 101 from adr=b.

As a result, addresses registered in the address register of the comparing/search apparatus 2 are: the start address=b and the end address=b−1. The addresses may be: the start address=b+1 and the end address=b. More specifically, if another search request (search 2) is input while at least one (comparing/search apparatus 1) of the comparing/search apparatus 104 is performing the “Search 1”, processing is performed as follows: the comparing/search apparatus 2 other than the comparing/search apparatus (search device) 1 performing the “Search 1” compares data output from the search database 101 for the “Search 1” being performed and a search key for another search (search 2). The comparing/search apparatus 2 sets the search end address of another search (search 2) to the address register of the comparing/search apparatus 2 based on the address where another search (search 2) was started. If the address monitoring apparatus 106 of the comparing/search apparatus 2 detects that the address generated by the search address generation apparatus 102 matches the search end address, the search 2 terminates.

If the search continues after the search by the comparing/search apparatus 1 terminates, and further the end address i for the initial search 1 is reached, the search is further performed by returning to the start address. Then, when the end address=b−1 is reached, the search by the search 2 terminates. The search by a single hit continues until the end address is reached only in a case where matching data is found at the end address or no matching data is found. Thus, even if a search is being performed by some comparing/search apparatus, output from the search database 101 can be used for searches by a plurality of comparing/search apparatuses if the searches are of the same type.

If the search 1 terminates after matching data is found in the search 2, address generation by the search address generation apparatus 102 is temporarily interrupted when the search 1 terminates. If the search 2 terminates after the search 1 terminates, address generation by the search address generation apparatus 102 is temporarily interrupted when the search 2 terminates. Address generation by the search address generation apparatus 102 is also temporarily interrupted when no matching data is found in the search 2 because a search by another comparing/search apparatus is not being performed if the search end address=b−1 of the comparing/search apparatus 2 is reached.

The time during which no search address is generated is used to write registration data into the search database 101. In an associative memory of the successive comparison method, a write operation into the search database 101 is prohibited in the search period because a comparison is made over a plurality of cycles. Thus, the time during which no search address is generated is detected by the address monitoring apparatus 106 to write data accumulated in the registration data buffer 103 into the search database 101. More specifically, the registration data buffer 103 stores data whose registration in the search database 101 is requested and, after a search by the comparing/search apparatus 104 terminates, data stored in the registration data buffer 103 is registered in the search database 101.

Subsequently, at time #5, a search 3 and a search 4 for the same search object are requested successively. The searches 3 and 4 are an ARP table search. Though the searches 3 and 4 are requested simultaneously, the searches 3 and 4 can be accomplished by using a plurality of the comparing/search apparatuses 1 and 2. Further, when a search 5 for a different search object is requested at time #6, the search request is registered in the search key register and address register of the comparing/search apparatus 3 available at this point. If the search 3 by the comparing/search apparatus 1 terminates at time #7, the search 4 by the comparing/search apparatus 2 continues and thus, a transition to search execution cannot occur immediately.

When the search 4 terminates at time #8, the start address stored in the address register of the comparing/search apparatus 3 is sent to the search address generation apparatus 102 to start the search 5. The search 5 is a routing table search. More specifically, if, while at least one of the units of the comparing/search apparatus 104 performs a search, there is another search request (search 5) that requests a search of data stored at an address different from that of the search being performed in the search database 101, the termination of the search being performed is awaited. Then, after the search being performed terminates, the search based on another search request (search 5) is started.

Even if a search result such as a response 5-1 or a search result 5-2 is output while a search is performed, address generation by the search address generation apparatus 102 and the search continue because the multi-hit is requested in the search 5. The search 5 terminates when output of the address by the search address generation apparatus 102 reaches the end address adr=k registered in the address register 105.

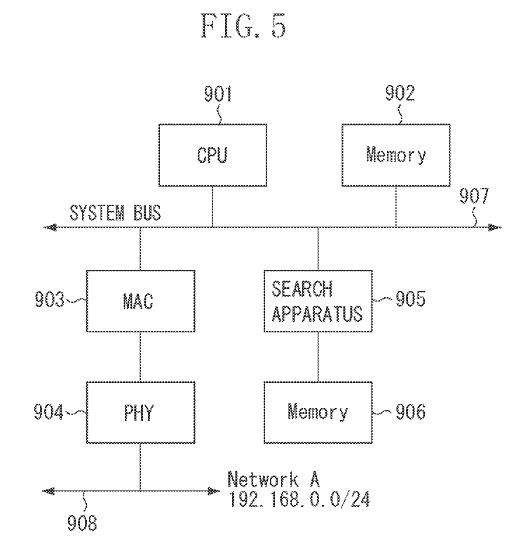

Next, based on the above description, an operation example of search processing accompanying network protocol processing will be described. FIG. 5 is a configuration example of a network apparatus (protocol processing apparatus). In FIG. 5, the network apparatus (protocol processing apparatus) including Media Access Control (MAC) 903 and a physical layer (PHY) 904 has a search apparatus 905 connected to a system bus. The configuration of the search apparatus 905 is similar to that illustrated in FIG. 1. The search apparatus 905 can perform, in response to a search request from a central processing unit (CPU) 901, a matching search between data in a search database arranged in a memory 902 on a system bus 907 or a memory 906 occupied by the search apparatus 905, and a search key of the search request.

In the configuration illustrated in FIG. 1, the search apparatus 905 contains the memory 906 and the search database 101 is provided in the memory 906. The network apparatus (protocol processing apparatus) performs network protocol processing using data stored in the search database 101. The CPU 901 performs network protocol processing based on a search result by the search apparatus 905 (comparing/search apparatuses 104). As the network protocol processing, the CPU 901 performs a plurality of search processing such as the ARP table search, socket table search, and routing table search.

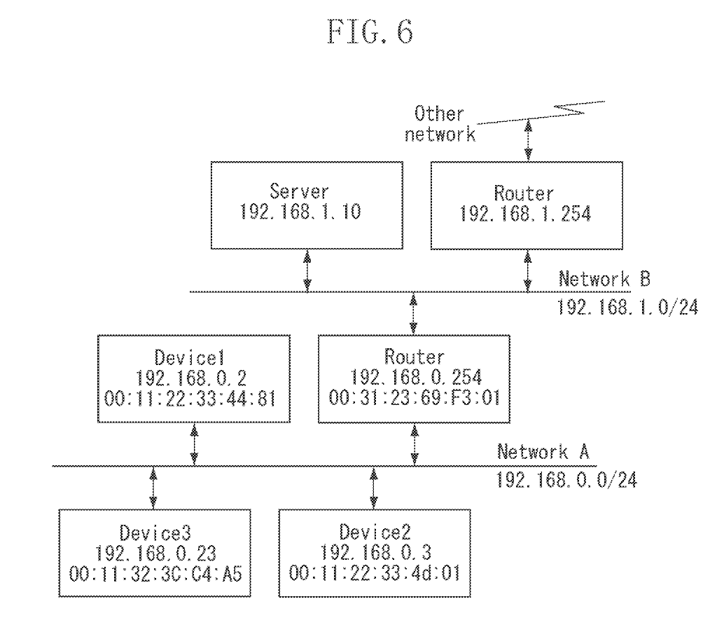

Behavior performed during packet transmission/reception when the network apparatus (protocol processing apparatus) is connected to a network as illustrated in FIG. 6 as Device 1 will be described. The configuration example and network example used in FIGS. 5 and 6 respectively are used to describe the operation of the search apparatus and do not limit the form in which the configuration example or network example is connected.

First, when an IP packet to be transmitted is prepared in the memory 902 of the network apparatus (protocol processing apparatus), the network apparatus performs an operation termed routing to decide the transfer destination of the packet by referring to a table to deliver the packet to the transmission address. The table used to decide routing is termed a routing table. The transfer destination is not necessarily a transmission destination and may be a relay device such as a router or L3 (Layer 3) switch to control network routes.

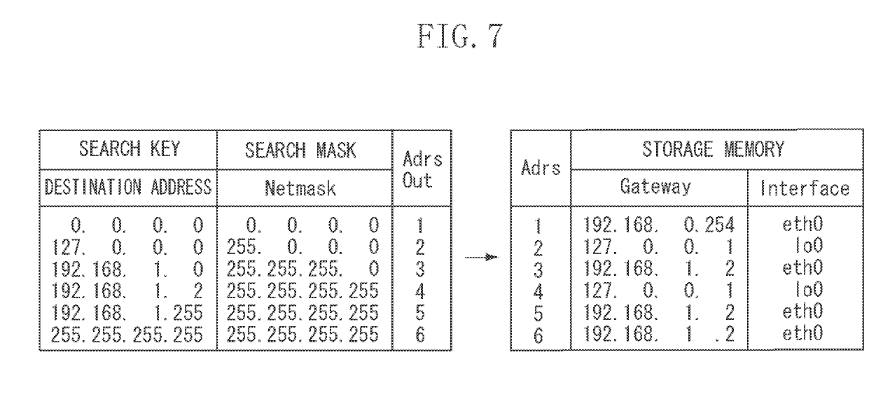

It is also necessary for an apparatus having no packet transfer function and having no 1-port network interface to perform routing and FIG. 7 exemplifies a routing table in such Device 1. When deciding the destination from the routing table, a method termed the longest match that selects a network having a long Netmask among matching networks, is used. The Netmask is a 32-bit value used for separating a network address to identify the network from an IP address.

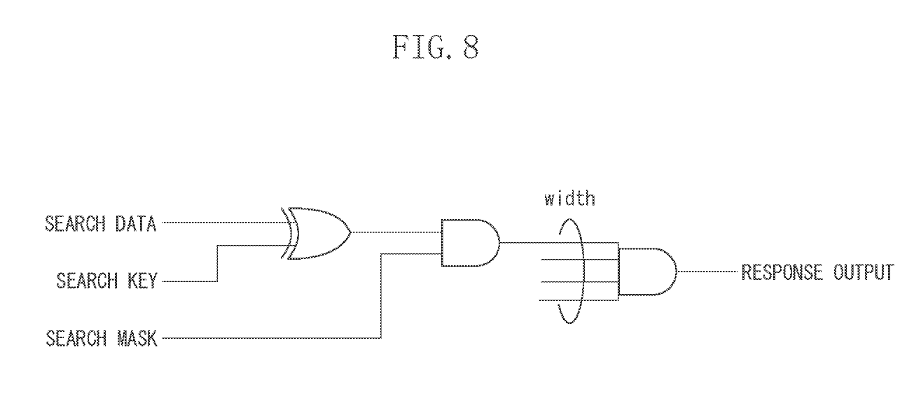

Thus, the comparator is constructed as illustrated in FIG. 8 so that an operation of filtering to enable/disable matching output of search data and a search key by a search mask is performed for each bit. This operation is performed for each Netmask to decide the longest match search result as the routing destination. A concrete example will be described below.

In the case of FIG. 7, searches of a total of four patterns are performed. Namely, the search when Netmask is 255.255.255.255, subsequently when Netmask is 255.255.255.0, when Netmask is 255.0.0, and when Netmask is 0.0.0.0 In the present exemplary embodiment, Netmask patterns are prepared in advance for four units of the comparing/search apparatus 104 and an address is input into each comparator when the destination address of the packet is identified so that searches of patterns (the above four patterns) of each Netmask can be started simultaneously. The destination address and Netmask (search mask) are read from the routing table of the search database 101 and then the destination address read from the routing table of the search database 101 and a search key are compared by the comparing/search apparatus that compares the read Netmask.

A longest match comparison result is obtained by adding a comparison result of each comparing/search apparatus when searches terminate, to a decode circuit based on priorities of the Netmask length (the longer Netmask length, the higher priority) (not illustrated). If matching data is obtained by the search whose Netmask is 255.255.255.255, the matching data is set as a search result. If no matching data is obtained by the search whose Netmask is 255.255.255.255 and matching data is obtained by the search whose Netmask is 255.255.255.0, the matching data is set as a search result. Subsequently, a result of the search based on 255.0.0.0 or that of the search based on 0.0.0.0 is successively adopted as a search result. Then, the storage memory based on the obtained result is referred to and an interface stored in the storage memory corresponding to the search result is decided as the interface to be output.

In the routing table search, the size of table itself is not generally large, but the search for each Netmask is needed so that improvement in speed can still be expected by, like the present exemplary embodiment, setting the same search address when the search of each Netmask length (the above four patterns) is performed in parallel.

If, as a result of routing, the transmission destination of the IP packet is to be an Ethernet (registered trademark) (eth0), it is necessary to add a MAC header to the head of the IP packet. Normally, an ARP table is available as a conversion table to a MAC address corresponding to an IP address. A destination MAC address corresponding to the table needs to be added to the MAC header of the IP packet to be transmitted. If no applicable IP address is found in the ARP table, an ARP request packet is broadcast to terminals of the network according to the address resolution protocol.

Assume, for example, that Device 1 transmits an ARP request packet to Network A and Device 3 transmits an ARP response packet to Device 1 in a network configured as illustrated in FIG. 6. Then, the IP address (192.168.0.23) and the MAC address (00:11:32:3C:04:A5) of Device 3 are registered in the storage memory of the ARP table of Device 1. If the ARP table information is present in Device 1, the MAC address can be obtained by referring to the ARP table without outputting an ARP packet.

According to the present exemplary embodiment, as described above, the search position of a search database can be determined by each search apparatus by preparing a search key register and an address register for each of a plurality of search apparatuses. Thus, an efficient search by the plurality of search apparatuses and various searches by the single search database can be achieved.

To operate various apparatuses to realize functions of the above exemplary embodiment, program code of software to realize functions of the above exemplary embodiment may be supplied to a computer in a system or an apparatus connected to the various apparatuses. Thus, exemplary embodiments realized by operating the various apparatuses according to the program stored in a computer (processor) of the system or the apparatus are also included in the scope of the present invention.

According to the present exemplary embodiment, as described above, search throughput can be improved by starting another search without waiting until a search being performed terminates.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-055212 filed Mar. 9, 2009, which is hereby incorporated by reference herein in its entirety.

What is claimed is:

1. An apparatus comprising:
a generation unit configured to generate an address to be provided to a database;
a plurality of search units; and
a processing unit configured to perform a network protocol processing based on a search result by the plurality of search units,
wherein each of the plurality of search units includes:
an input unit configured to input a search key;
a comparison unit configured to compare data output from the database according to the generated address and the search key;
a setting unit configured to set a search start address and a search end address; and
a monitoring unit configured to monitor matching of the generated address and the search end address.

2. The apparatus according to claim 1, wherein
if another search request is issued while at least one of the plurality of search units is performing a search, data output from the database for the search being performed and the search key for another search are compared by a second search unit and the search end address of another search is set based on the address where another search is started.

3. The apparatus according to claim 2, wherein if, while at least one of the plurality of search units is performing a search, another search request that requests a search of data stored at an address different from the address of the search being performed in the database is issued, the search based on another search request is started after the search being performed terminates.

4. The apparatus according to claim 2, further comprising a storage unit configured to store data whose registration in the database is requested, wherein after the search by the plurality of search units terminates, the data stored in the storage unit is registered in the database.

5. A method comprising:
inputting a search key by an input unit;
generating an address to be provided to a database;
setting a search start address and a search end address;
comparing data output from the database according to the generated address and the search key; and
monitoring matching of the generated address and the search end address.

6. The method according to claim 5,
wherein if another search request is issued while at least one of a plurality of search units is performing a search, data output from the database for the search being performed and the search key for another search are compared by a search device other than the search device performing the search, and the search end address of another search is set based on the address where another search is started.

7. The method according to claim 6, wherein if, while at least one of the plurality of search units is performing a search, another search request that requests a search of data stored at a different address, the search based on another search request is started after the search being performed terminates.

8. The method according to claim 6, further comprising storing data whose registration in the database is requested, wherein after the search terminates, the stored data stored.

9. A computer readable storage medium storing computer-executable program of instructions for causing a computer to perform a method comprising:
inputting a search key by an input unit;
generating an address to be provided to a database;
setting a search start address and a search end address;
comparing data output from the database according to the generated address and the search key; and
monitoring matching of the generated address and the search end address.
